(19) United States
(12) Patent Application Publication
(10) Pub. No.: US 2025/0010514 A1
(43) Pub. Date: Jan. 9, 2025

(54) TURNING DEVICE

(71) Applicant: EBAWE Anlagentechnik GmbH, Eilenburg (DE)

(72) Inventor: Marcus SCHELER, Eilenburg (DE)

(21) Appl. No.: 18/763,101

(22) Filed: Jul. 3, 2024

(30) Foreign Application Priority Data
Jul. 6, 2023 (EP) 23183848.3

(51) Int. Cl. B28B 15/00; B28B 17/00

(52) U.S. Cl. CPC B28B 15/005; B28B 17/0081

(57) ABSTRACT

A turning device for fully automated turning in of a first double-walled part at least in some portions into a second double-walled part. The turning device includes: a turning frame, wherein the first double-walled part can be arranged at least in some portions within the turning frame, a drive unit for the automated rotation of the turning frame in a space, a fixing element arranged on the turning frame, by which a first double-walled part arranged at least in some portions within the turning frame can be fixed relative to the turning frame, and a controlling and/or regulating device for controlling the drive unit. The fixing element is displaceably and/or pivotably attached to the turning frame, and an actuating device is provided, by which the fixing element is displaceable and/or pivotable in an automated manner relative to the turning frame.

### BACKGROUND OF THE INVENTION

The invention concerns a turning device for the construction industry for the fully automated turning in of a first double-walled part at least partially into a second double-walled part. The turning device comprises at least one turning frame, and the first double-walled part can be arranged at least in some portions within the at least one turning frame. At least one drive unit is provided for the automated rotation of the at least one turning frame in a space, and at least one fixing element is arranged on the at least one turning frame, by which a first double-walled part arranged at least in some portions within the turning frame can be fixed relative to the at least one turning frame, and at least one controlling and/or regulating device is provided for controlling the at least one drive unit. Furthermore, the invention also concerns a method for the fully automated bracing of a first double-walled part by means of such a turning device.

Such a turning device is already known, for instance, from EP 2 934 837 A2, in which precast concrete wall elements of varying thicknesses are rotated by a turning device. For fixing during the rotation process, clamping devices with bendable holding elements for fixing the precast concrete wall elements are arranged on the turning device so as to be moveable in a vertical direction, wherein the clamping devices are pivoted and displaced relative to the precast concrete wall elements. This way, the number of clamping devices for various thicknesses can be reduced, wherein no manual removal and reinsertion of the clamping devices is required due to the pre-assembly on the turning device. The holding elements of the clamping devices are pivoted upwards, starting from a bent release position, for fixing around a horizontal axis along a longitudinal extension of the precast concrete wall element, and subsequently moved laterally relative to the precast concrete wall element to be fixed by a translatory movement along a direction orthogonal to the longitudinal extension in order to generate a form fit. The clamping devices are arranged in the form of a grid along the turning device, and always have a position in the direction orthogonal to the longitudinal extension that is determined by the design of the holding elements.

However, this concept of fixing the precast concrete wall elements is very limited with regard to the variability of the precast concrete wall elements in a plane of the precast concrete wall elements. The production of precast concrete wall elements is limited to trivial rectangular plates of a defined shape, and customer requests for complex customized products can not be met. In addition, for deviating dimensioning of precast concrete wall elements, the grid of clamping devices must be adapted, or a deviating grid of clamping devices must be provided. In other words, such a turning device cannot be used flexibly.

Furthermore, problems would arise in particular with insulated double walls. This would require adapters or an additional adjustment option in order to be able to adapt the turning device to different insulations, in particular insulation heights.

### SUMMARY OF THE INVENTION

The object of the present invention is therefore to provide a turning device, which is improved over the prior art, as well as a method for the fully automated bracing of double-walled parts, in which the disadvantages of the prior art are at least partially eliminated.

According to the invention, the at least one fixing element is displaceably and/or pivotably attached to the at least one turning frame, wherein at least one actuating device is provided, via which the at least one fixing element is displaceable and/or pivotable in an automated manner relative to the at least one turning frame.

This way, it is possible to produce a form fit between the at least one fixing element and the double-walled parts arranged in the at least one turning frame. Thereby, the position of the at least one fixing element can be adapted in an automated manner by displacing and/or pivoting it to varying dimensions and geometries of the double walls to be produced, wherein in particular complex geometries and shapes of double-walled parts can be securely fixed within the at least one turning frame.

For instance, a plurality of double-walled parts or double walls can be produced simultaneously, wherein the individual double-walled parts, that can be maneuvered in a turning process, can differ in their geometry. This way, an area of a pallet to be turned can be used optimally, wherein time and resources can be saved.

In particular, manual assembly steps are no longer required due to the automated ability to displace and pivot the at least one fixing element. This way, the bracing of a double-walled part in a turning frame can be accelerated and, on the other hand, a production process that is gentler on workers can be ensured, as the high weights of the fixing elements, which are due to the necessary robustness, no longer have to be positioned conventionally, i.e. manually.

The fixing elements can ensure that, for instance, a conventional connection between edge formwork and the pallet is increased by means of magnets so that parts of the double-walled parts are prevented from falling out. The connection between the at least one turning frame and/or the first double-walled part can, for example, be magnetic, pneumatic, hydraulic, spring-loaded and/or via an electric drive. Preferably, a holding force is transmitted further to the turning device by a rigid connection between the pallet and the at least one turning frame.

In addition, there is, on top of that, the positive characteristic that an adjustment of a fixing scheme (for instance due to changed geometries or different masses to be maneuvered) can be carried out quickly and user-friendly in the at least one controlling and/or regulating device without the need to engage in any design work.

The shape of double-walled parts and/or the localization of fixing points for the at least one fixing means can be predefined or defined, and, for instance, also initiated via the at least one controlling and/or regulating device. A human-machine interface (HMI) has proven to be particularly advantageous for this purpose, wherein fixing layouts (predefined or to be defined) and/or adjustments can be created or made manually, via templates or by an algorithm. All automated components can be controlled by the same or separate controlling and/or regulating devices. Data can be transmitted by cable (for instance as an integral part of the turning device) or by means of a radio signal-transmitting data connection.

A method according to the invention has the following steps, in particular in chronological order:
the first double-walled part is arranged at least in some portions within the at least one turning frame
the at least one controlling and/or regulating device displaces the at least one fixing element, preferably in a direction essentially orthogonal to a longitudinal extension of the turning frame, by means of the at least one actuating device
the at least one displaced fixing element is used to fix the first double-walled part arranged at least in some portions within the turning frame relative to the at least one turning frame
the at least one drive unit is used to rotate in an automated manner the at least one turning frame in a space via the at least one controlling and/or regulating device.

The method can be used flexibly for the most different arrangements of edge formwork, and a wide range of double walls can be efficiently covered.

For instance, the controlling and/or regulating device can comprise an algorithm in the form of a computer program product by which a computing unit, which is in a data connection with a storage unit or can be brought into such a connection, executes at least parts of the method. The computer program product can be transmitted via a data carrier signal and/or stored on a data memory.

According to a preferable embodiment, the at least one controlling and/or regulating device is designed in such a way as control the at least one actuating device in such a way that the at least one fixing element is displaced and/or pivoted relative to the at least one turning frame.

By programming the controlling and/or regulating device accordingly, the fixing elements can therefore be pivoted and displaced in an automated manner so that a double-walled part is fixed in a turning frame.

It has also proved to be advantageous when at least one guide carriage is arranged displaceably and/or pivotably on the at least one turning frame, wherein the at least one fixing element is arranged displaceably in or on the at least one guide carriage.

The at least one guide carriage thereby represents a simple option of arranging a fixing element pivotably and/or displaceably on a turning frame. The displaceability of the guide carriage thereby serves to displace the fixing element, preferably along a longitudinal extension of a turning frame, whereby the position of the guide carriage or, subsequently, also the fixing elements on the turning frame can be adapted. This means that different geometries of double-walled parts can be taken into account.

By the pivotability of the guide carriages, the fixing elements can be pivoted in such a way that they are arranged as close as possible to the turning frame, particularly in a state in which no double-walled part is fixed in the turning device. This way, the turning circle of the turning frame can be kept as small as possible.

Via the displaceable arrangement of the fixing element in or on the guide carriage, the fixing element can then be moved over a double-walled part, thus fixing the double-walled part. Advantageously, the displaceability according to an aspect of the invention corresponds to such a displacement.

The at least one actuating device can have at least one actuating element, preferably a drive wheel, which can be driven via at least one drive device in order to displace the at least one fixing element relative to the at least one turning frame, preferably relative to at least one guide carriage, preferably wherein the at least one drive device can be controlled by the at least one controlling and/or regulating device.

An actuating element is thereby a simple way of contacting a fixing element, especially if the actuating element is designed as a drive wheel.

The drive wheel can contact a fixing element, wherein a frictional connection is then present between the drive wheel and the fixing element.

A movement of the drive wheel can accordingly be transmitted to a fixing element via friction. In particular, it is possible in this way to convert a rotational movement of the drive element into a linear movement of the fixing element, i.e. to displace the fixing element.

The drive wheel can thereby be driven by the drive device, which can be controlled by the controlling and/or regulating device. This contributes to enabling an automated turning process.

According to an additional embodiment of the present invention, the at least one actuating device can comprise a gripping device with which an at least temporarily motion-coupled connection can be established between the at least one fixing element and the at least one actuating device, preferably wherein the at least one actuating element is part of the gripping device.

A fixing element can be gripped via the gripping device, thus motion-coupled with the gripping device at least temporarily (for the time in which it is gripped). A fixing element can then also be adjusted, and thus positioned via a movement of the actuating device.

It is thereby provided that the gripping device is designed in the form of a jaw gripper, preferably with two jaws. This is a simple way of realizing a gripping device.

The gripping device can also provide contact means for contacting the fixing element, wherein the contact means are preferably arranged on the jaws of the gripping device.

At least one of the contact means can thereby be designed by the actuating element. The other ones or the other one contact means are preferably embodied as rollers.

So, the gripping device can grip the fixing element, wherein this is contacted by the contact means. This way, on the one hand, the fixing element can then be repositioned (verstellt) (i.e. displaced and/or pivoted) by moving the actuating device, and, on the other hand, the actuating element can be used to displace the fixing element, preferably into a position in which a double-walled part is fixed.

Advantageously, the gripping device can be rotatably positioned, preferably on a base body of the actuating device.

Preferably, it can additionally be provided that the at least one actuating device:
is guided displaceably and/or pivotably along a guide arranged on or adjacent to the at least one turning frame, preferably along a longitudinal extension of the at least one turning frame, and/or
is arranged on a manipulator or is part of a manipulator, or
is arranged on the at least one guide carriage.

The actuating device can be moved along the turning frame via a guide of the actuating device along a guide arranged on or adjacent to the at least one turning frame. In particular, when a plurality of fixing elements are provided, several fixing elements can then be pivoted and/or displaced by means of only one actuating device, since the actuating device can move to the corresponding positions of the fixing elements.

Even if the actuating device is arranged on a manipulator or is part of a manipulator, several fixing elements can be displaced and/or pivoted by means of an actuating device. A wide variety of manipulators known from the prior art can thereby be used as manipulators, for instance in the form of gantry robots or robot arms.

In the two embodiments mentioned above, it is particularly advantageous when the actuating device has a gripping device.

Alternatively (or in addition to it), the actuating device can be arranged on the at least one guide carriage. This represents a technically less complex option for arranging an actuating device. However, such an embodiment is associated with higher material costs, since each fixing element must be provided with an actuating device.

Preferably, at least one additional drive device is provided, by which the at least one actuating device and/or the at least one guide carriage is displaceable and/or pivotable, preferably along a longitudinal extension of the at least one turning frame.

As already mentioned, this means that a plurality of fixing elements can be displaced and/or pivoted by means of just one actuating device.

Thereby, it is particularly advantageous when the at least one controlling and/or regulating device is designed in such a way to control the at least one additional drive device in such a way that the at least one actuating device, preferably together with the at least one fixing element, which is at least temporarily motion-coupled with the actuating device, or the at least one guide carriage, can be positioned on the at least one turning frame depending on a geometry of a first double-walled part.

This facilitates the ability to automate the turning process.

A plurality of fixing elements, preferably along a longitudinal extension of the at least one turning frame, can be provided on the at least one turning frame. Preferably, an actuating device is provided for each fixing element, or a number of actuating devices, preferably one or two actuating devices smaller than the plurality of fixing elements, are provided.

A double-walled part can be fixed more securely and in a better way to a turning frame by a plurality of fixing elements. Depending on the selected embodiment, the required number of actuating devices can then also be selected.

Advantageously, the at least one turning frame and/or the at least one drive unit can be arranged on a machine frame. Preferably, the at least one turning frame is designed to be rotatable relative to the machine frame, and/or the machine frame comprises at least one lifting unit for vertically lifting the at least one turning frame relative to the machine frame in a state of use of the turning device.

This way, the first double-walled part can be prepared for being turned in into the second double-walled part at a low height while conserving resources, wherein the first double-walled part is lifted and rotated so that it can be arranged in some portions in the second double-walled part.

According to an additional embodiment of the present invention, the pivoting and/or displacement of the at least one fixing element takes place in a plane parallel to a plane braced by the turning frame.

This way, excessive space requirements of a fixing element during a movement of pivoting or displacing can be avoided.

According to a preferred embodiment of the invention, the turning device is provided with at least one first double-walled part arranged in the at least one turning frame, and preferably the first double-walled part comprises:
at least one, particularly preferably metallic, pallet for arranging liquid concrete on the pallet, and/or
at least one edge formwork for the local confinement of liquid concrete on the pallet, and/or
at least one reinforcement for increasing the stability of the first double-walled part after the liquid concrete on the pallet has hardened, and/or
at least one lattice girder projecting from the solid concrete arranged on the pallet for contacting a second double-walled part, and/or
at least one insulation arranged on the solid concrete (BS) arranged on the pallet.

The second double-walled part is generally constructed as a mirror image of the first double-walled part, wherein preferably merely the first double-walled part comprises a reinforcement comprising a lattice girder. However, (reinforcing) mats, connecting pins or an insulation can also be arranged additionally or alternatively on or in at least one of the double-walled parts.

It has proven to be advantageous when the first double-walled part comprises a fixed edge formwork adjacent to the at least one turning frame and/or a separate edge formwork that can be variably placed on the pallet, wherein the at least one fixing element contacts the fixed edge formwork and/or the variably placeable edge formwork and/or the at least one lattice girder and/or the solid concrete arranged on the pallet and/or the insulation and/or the reinforcement for bracing the first double-walled part against the at least one turning frame.

By means of the fixed edge formwork, a structural variable of the pallet can be utilized particularly efficiently, wherein the variably placeable edge formwork eliminates the need for special designs for complex geometries on double walls to be produced. As it is generally merely the arrangement of the variably placeable edge formwork that changes, two categories of fixing means, each with their own specific advantages, have proven to be particularly advantageous.

Regarding a method according to the invention:
the at least one additional drive unit is controlled via the at least one controlling and/or regulating device in such a way that the at least one actuating device, preferably together with the at least one fixing element at least temporarily motion-coupled with the actuating device, or the at least one guide carriage, is displaced depending on a geometry of a first double-walled part on the at least one turning frame, preferably in a direction essentially parallel to a longitudinal extension of the turning frame, and/or
the at least one actuating device, preferably together with the at least one fixing element, which is at least temporarily motion-coupled with the actuating device, or the at least one guide carriage is pivoted, preferably before the at least one actuating device, or the at least one guide carriage is displaced.

According to an advantageous embodiment of the invention, in a subsequent method step, the second double-walled part is connected to the first double-walled part via a lattice girder to form a double wall, wherein the double wall is formed by curing concrete arranged in the second double-walled part, and separating a pallet, edge formwork and/or fixing means which are arranged on the first double-walled part and/or on the second double-walled part.

The double wall can already be considered as present by connecting the two double-walled parts or only after removal of the component parts which are required for production. A loosening and/or fixing, preferably bracing, of the at least one fixing element can, for instance, be triggered via the at least one controlling and/or regulating device. An HMI has hereby proven to be advantageous, wherein the geometries of the double-walled parts and/or positions for the at least one fixing means can be defined in a particularly advantageous manner via the HMI-possibly supported by an algorithm.

### BRIEF DESCRIPTION OF THE DRAWINGS

More details and advantages of the invention are explained in greater detail below with reference to the drawings, in which:

FIG. 1 is a schematic view of a turning-in process of a first double-walled part into a second double-walled part to form a double wall in a side view,

FIGS. 2a, 2b is a schematic view of a turning device with a plurality of fixing elements projecting through a turning frame according to the state of the art in a view from above and a view from the side,

FIG. 3a is a schematic, perspective view of a first embodiment of a turning device,

FIG. 3b is a schematic, perspective view of a second embodiment of a turning device, shows various steps for the fully automated bracing of a first double-walled part FIGS. 4a-f by means of a turning device in a schematic top view according to the first embodiment,

FIGS. 5a-c is a schematic, perspective view of an embodiment of an actuating device with a gripping device in various positions,

FIG. 6a is a schematic side view of a part of a turning device according to the second embodiment,

FIG. 6b is a schematic top view of a part of a turning device according to the second embodiment, and

FIG. 6c is a schematic top view of a part of a turning device according to the second embodiment, wherein the fixing elements are displaced.

### DETAILED DESCRIPTION OF THE INVENTION

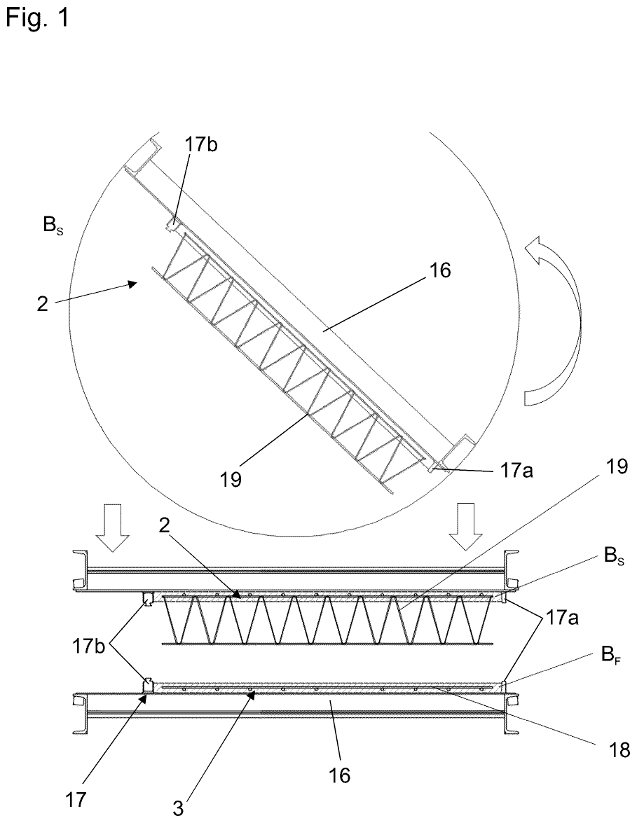

FIG. 1 shows a schematic view of a turning-in process of a first double-walled part 2 into a second double-walled part 3, wherein the first double-walled part 2 is inserted vertically into the second double-walled part 3. In general, the second double-walled part 3 can also be lifted vertically, or the connection of the two double-walled parts 2, 3 can be generated in the course of a pivoting process.

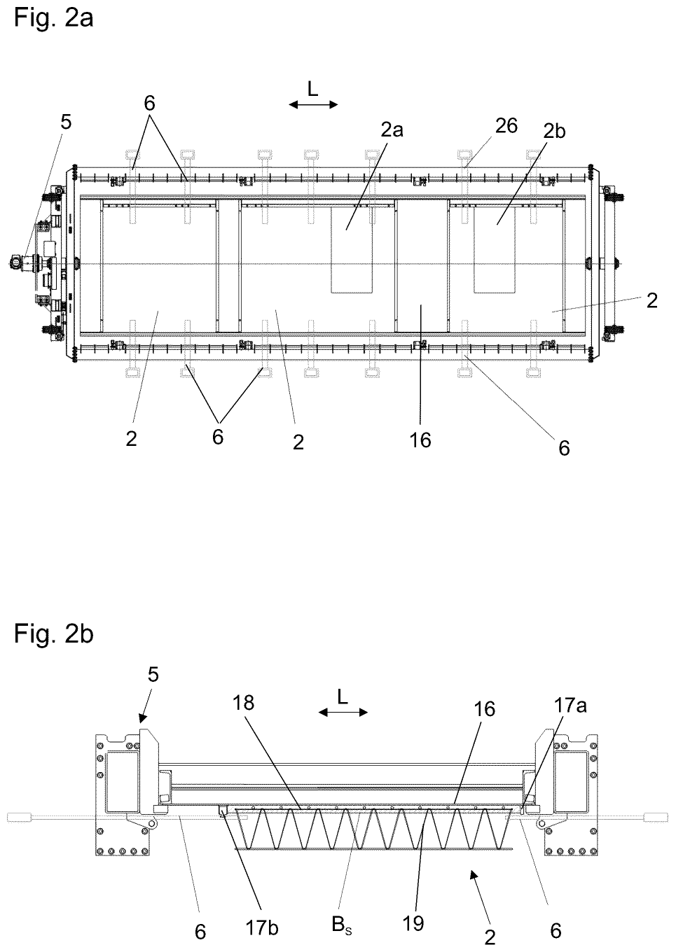

FIG. 2a shows a turning device 1 with which three first double-walled parts 2, arranged on a pallet 15, can be turned and arranged in some portions in a second double-walled part 3. A first double-walled part 2 comprises a window 2a, and another double-walled part 2 comprises a door 2b. In the prior art, the clamping devices can cause undesirable damage to such sensitive portions of the first double-walled part 2. Moreover, the clamping devices in the prior art are generally arranged in a grid in such a way that the first double-walled parts 2 are not supported symmetrically during the turning process (for example, due to the gaps between the first double-walled parts 2 specific for this arrangement).

The fixing means 6 used in FIG. 2a are arranged manually at positions predetermined by corresponding predefined openings, wherein no variability in the longitudinal direction can be obtained. Furthermore, no first double-walled parts 2 can be covered, which merely extend partially across a width of the pallet 3. The fixing means 6 are not designed according to the invention, and, in particular, are not arranged, in an automated manner according to the invention, variably at any desired position on the pallet 15 by means of a controlling and/or regulating device 7.

FIG. 2b differs from FIG. 2a merely in such a way that the turning device 1 is shown rotated by 90°. Essentially, the structural design of the embodiment shown in FIG. 2a and FIG. 2b can be applied to a turning device 1 according to the invention, wherein the fixing means 6 used can be provided in addition to the fixing means 6 according to the invention.

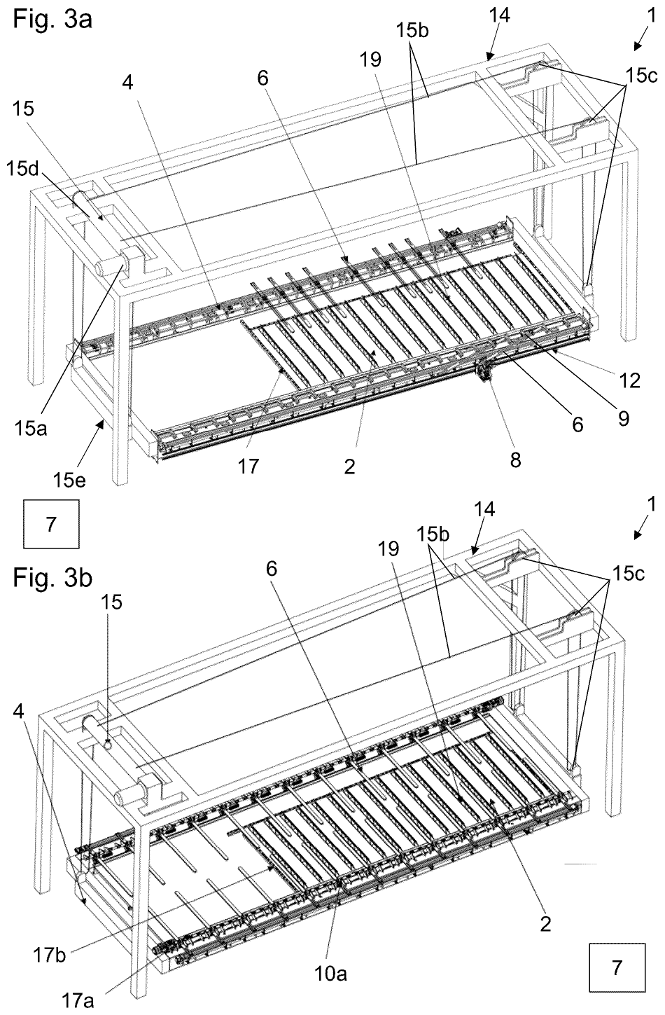

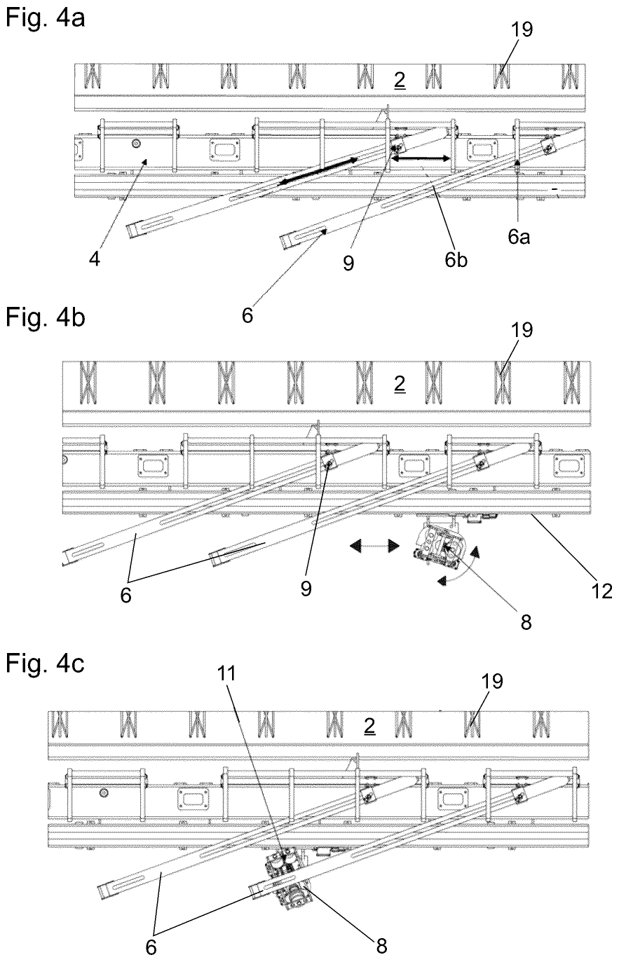

FIG. 3a shows a schematic, perspective view of a first embodiment of a turning device 1 according to the invention. A machine frame 14 is visible, which forms the basis for the turning device 1. Parts of a lifting unit 15 are arranged on the machine frame 14.

The lifting unit 15 thereby comprises a drive 15a, for instance in the form of an electric motor, which can drive a cable drum 15d. Wire ropes 15b can be wound onto and unwound from the rope drum 15d. The wire ropes 15b are connected to a bearing device 15e, wherein the turning frame 4 can be positioned on the bearing device 15e. Several pulleys 15c for deflecting the wire ropes 15b are also visible. A first double-walled part 2 is braced in the turning frame 4. The first double-walled part 2 thereby has lattice girders 19.

In addition, an edge formwork 17 is visible, in which the first double-walled part 2 has been produced.

For a turning process, the turning frame 4 is lifted via the lifting device 15. Then, the turning frame 4 is turned around an axis parallel to its longitudinal extension L. A drive unit 5 is provided, which is not shown in the present figure for the sake of clarity. Finally, the turned turning frame 4 can be lowered again by means of the lifting device 15. Thereby, the first double-walled part 2 can be brought in into a second double-walled part 3 (not shown) via the lattice girders 19 in order to produce a double wall.

In the embodiment according to FIG. 3b, a plurality of fixing elements 6 are provided, which are displaceably positioned in guide carriages 9. The guide carriages 9 are thereby again positioned on the turning frame 4 so as to be displaceable and pivotable. Thereby, the fixing elements 6 are already brought into position on one side, and thus brace the first double-walled part 2 on the turning frame 4. On the other side, the fixing elements are still in a pivoted position (i.e. not orthogonal to the turning frame 4) and must first be positioned by means of the actuating device 8. For this, the actuating device 8 is positioned on the turning frame 4 so that it can be displaced and pivoted. It is of course also conceivable that the actuating device 8 is positioned next to the turning frame 4 or that a manipulator is provided, on which the actuating device 8 is arranged, or which has the actuating device 8.

A clamping process according to this embodiment is explained in more detail in FIGS. 4a to 4f.

The embodiment according to FIG. 3b essentially differs only in the design of the actuating device 8 and the fixing elements 6.

Here, the fixing elements 6 are again positioned displaceably in the guide carriages 9. The guide carriages 9 are thereby displaceably arranged on the turning frame 4. Basically, it would also be conceivable to displaceably and pivotably position the guide carriages 4 on the turning frame 4 also in this embodiment.

The formwork 17 can be divided into a fixed edge formwork 17a, which is arranged in a fixed manner on the pallet 16, and a variably placeable edge formwork 17b, which can be placed variably on the pallet.

A controlling and/or regulating device 7 is only shown schematically in these figures. The controlling and/or regulating device 7 can thereby be arranged on the machine frame 14, or separate therefrom, and be in contact with the facilities of the turning device 1 via various means already known.

An actuating element 8a of an actuating device 8 is arranged on each of the guide carriages 9, via which the fixing elements 6 can be displaced relative to the guide carriages 9. For this, a drive shaft 10a is also provided to drive the actuating elements 8a.

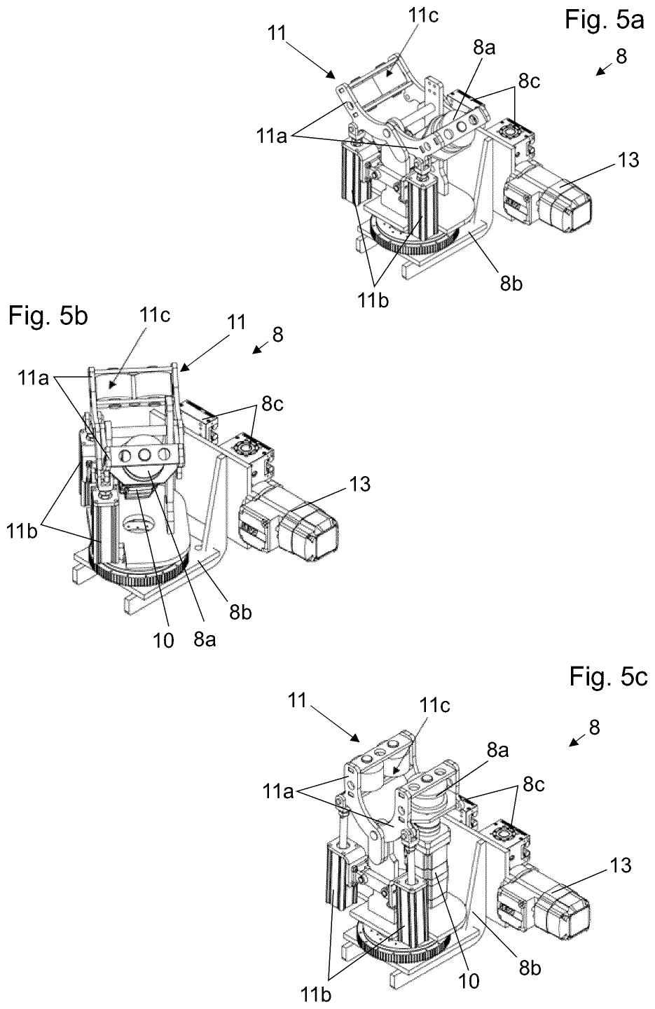

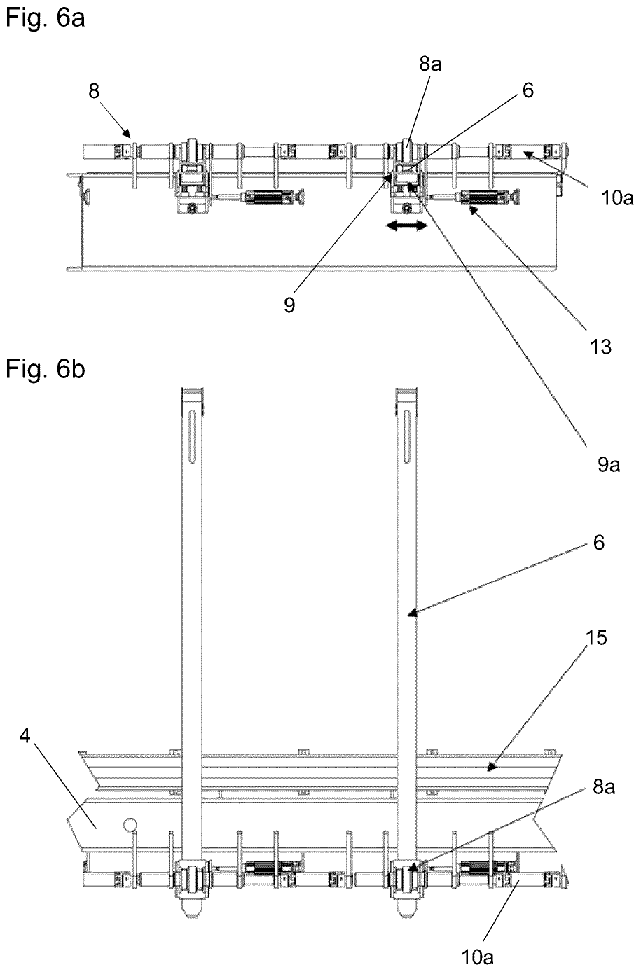

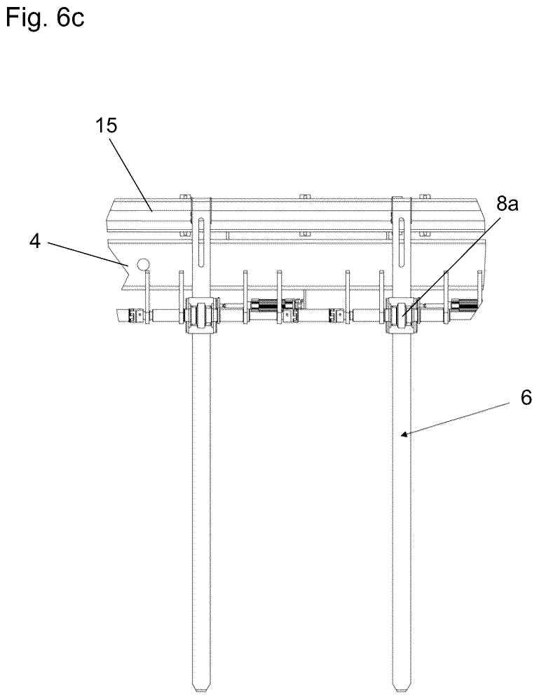

The clamping process to this embodiment is explained in more detail in FIGS. 6a to 6c. FIGS. 4a to 4f show various steps for the fully automated bracing of a first double-walled part 2 via a turning device 4 in a schematic top view according to the first embodiment.

A first double-walled part 2 is visible, which is arranged in a turning frame 4. Several fixing elements 6 are provided on the turning frame 4, which are displaceably positioned in guide carriages 9. The fixing elements 6 have grooves 6a in order to limit such a movement of displacing. Moreover, the guide carriages 9 are displaceably and pivotably positioned on the turning frame 4. The travel ranges of the fixing elements 6 and the guide carriages 9 are thereby indicated by arrows.

Furthermore, abutments 6a are also visible, by means of which the fixing elements 6 can be fixed.

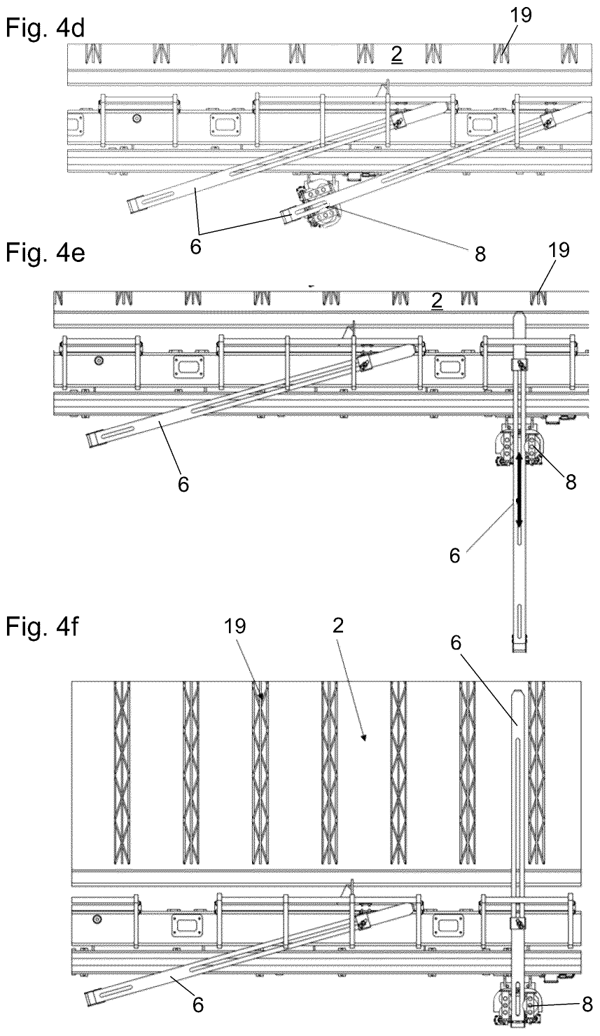

An actuating device 8 (FIG. 4b) is positioned displaceably and pivotably on the turning frame 4. For this, a guide 12 is provided, on which guide elements 8c of the actuating device 8 are positioned. The actuating device 8 moreover has a gripping device 11. Again, the possible movements of the actuating device 8 are indicated by arrows. The design of the actuating device 8 according to this embodiment is explained in more detail in FIGS. 5a to 5c.

As visible in FIG. 4c, the actuating device 8 can be positioned accordingly in order to grip a fixing element 6. In FIG. 4d, the fixing element 6 has been gripped by means of the actuating device 8, after which the actuating device 6 and the fixing element 6 are connected in a motion-coupled manner.

By means of a method and pivoting of the actuating device, the fixing element 6 can be pivoted (FIG. 4e). Before or after pivoting the fixing element 6, the fixing element 6 together with the actuating device 8 can be displaced along the turning frame 4 by the actuating device 8. This way, the fixing element 6 can be positioned on the turning frame 4 depending on the geometry of the first double-walled part 2 (for instance lattice girder 19, window 2a or door 2b).

The fixing element 6 can then be displaced relative to the guide carriage 9 (see arrow in FIG. 4e) via the actuating device 8, in particular via the actuating element 8a, so that the first double-walled part 2 can be braced (FIG. 4f). This process can then be repeated for all fixing elements 6.

In particular, it is also conceivable that several of such actuating devices 8 are provided in order to accelerate a clamping process.

FIGS. 5a to 5c show such an actuating device 8 in various positions. FIG. 5a shows an “initial position”. A base body 8b is visible. Guide elements 8c are arranged on the base body 8b, which can be displaceably positioned on a guide 12. Moreover, a further drive device 13 is visible, by means of which the actuating device 8 can be moved along the guide 12.

The actuating device 8 comprises a gripping device 11. The gripping device 11 is thereby designed as a jaw gripper, which has two gripper jaws 11a. The gripper jaws 11a can be opened or closed via actuators 11b. The actuators 11b can, for instance, be designed as pneumatic or hydraulic cylinders, or they can be electrically operated.

The actuating element 8 is designed here in the form of a drive wheel, which can be driven via a drive device 10. The actuating element 8a is thereby arranged on one of the gripper jaws 11a. The other gripper jaw 11a has guide rollers 11c.

The guide rollers 11c and the actuating element 8a therefore form contact means via which a fixing element 6 can be contacted.

The gripping device 11 is rotatably or pivotably positioned on the base body 8b (FIG. 5b). Preferably, a rotational movement can be carried out by means of the additional drive device 13. However, it is also conceivable that an additional drive device is provided.

In FIG. 5c, the actuating device 8 is shown in a position in which the gripping device 11 is closed, thus a fixing element 6 engages in.

FIG. 6a shows a schematic side view of a part of a turning device 1 according to the second embodiment, FIG. 6b shows a schematic top view thereof, and FIG. 6c shows a schematic top view of a part of a turning device 1 according to the second embodiment, wherein the fixing elements 6 are displaced.

Further drive devices 13 are visible, via which the guide carriages 9 can be displaced, which is indicated by an arrow. The guide carriages 9 can therefore be positioned on the turning frame 4 via the further drive devices 13 depending on the geometry of the first double-walled part.

Thereby, an actuating element 8a in the form of a drive wheel is provided on each guide carriage 9. The actuating elements 8a can be driven by the drive device 10 (not shown) via a drive shaft 10a. The fixing elements 6 can be brought into contact or out of contact with the actuating elements 8a via a pressure roller 9a.

By driving the actuating elements 8a, the fixing elements 6 can be adjusted relative to the guide carriages 9 so that a first double-walled part 2 is braced to the turning frame 4 (FIG. 6c).

### LIST OF REFERENCE SIGNS

1 turning device
2 first double-walled part
3 second double-walled part
4 turning frame
5 drive unit
6 fixing element
   6a abutment
   6b groove
7 controlling and/or regulating unit
8 actuating device
   8a actuating element
   8b base body
   8c guide elements
9 guide carriage
   9a contact pressure roller
10 drive device
   10a drive shaft
11 gripping device
   11a gripper jaws
   11b actuator
   11c guide roller
12 guide
13 additional drive device
14 machine frame
15 lifting unit
   15a drive
   15b wire ropes
   15c pulley
   15d rope drum
   15e bearing device
16 pallet
17 edge formwork
   17a fixed edge formwork
   17b variably placeable edge formwork
18 reinforcement
19 lattice girder

1. A turning device for the construction industry for fully automated turning in of a first double-walled part at least in some portions in a second double-walled part, the turning device comprising:
at least one turning frame, wherein the first double-walled part can be arranged at least in some portions within the at least one turning frame,
at least one drive unit for the automated rotation of the at least one turning frame in a space,
at least one fixing element arranged on the at least one turning frame, with which a first double-walled part arranged at least in some portions within the turning frame can be fixed relative to the at least one turning frame, and
at least one controlling and/or regulating device for controlling the at least one drive unit,
wherein the at least one fixing element is displaceably and/or pivotably attached to the at least one turning frame, wherein at least one actuating device is provided, via which the at least one fixing element is displaceable and/or pivotable in an automated manner relative to the at least one turning frame.

2. The turning device according to claim 1, wherein the at least one controlling and/or regulating device is designed in such a way that the at least one actuating device is controlled so that the at least one fixing element is displaced and/or pivoted relative to the at least one turning frame.

3. The turning device according to claim 1, wherein at least one guide carriage is arranged displaceably and/or pivotably on the at least one turning frame, wherein the at least one fixing element is arranged displaceably in or on the at least one guide carriage.

4. The turning device according to claim 1, wherein the at least one actuating device has at least one actuating element, preferably a drive wheel, which can be driven via at least one drive device for displacing the at least one fixing element relative to the at least one turning frame, preferably relative to at least one guide carriage, preferably wherein the at least one drive device can be controlled by the at least one controlling and/or regulating device.

5. The turning device according to claim 1, wherein the at least one actuating device comprises a gripping device, with which an at least temporarily motion-coupled connection can be produced between the at least one fixing element and the at least one actuating device, preferably wherein the at least one actuating element is part of the gripping device.

6. The turning device according to claim 1, wherein the at least one actuating device:
is guided along a guide arranged on or next to the at least one turning frame, preferably along a longitudinal extension of the at least one turning frame, so as to be displaceable and/or pivotable, and/or
is arranged on a manipulator or is part of a manipulator, or
is arranged on the at least one guide carriage.

7. The turning device according to claim 3, wherein at least one additional drive device is provided, via which the at least one actuating device and/or the at least one guide carriage is displaceable and/or pivotable, preferably along a longitudinal extension of the at least one turning frame.

8. The turning device according to claim 7, wherein the at least one controlling and/or regulating device is designed to control the at least one additional drive device in such a way that the at least one actuating device, preferably together with the at least one fixing element, which is at least temporarily motion-coupled to the actuating device, or the at least one guide carriage, can be positioned on the at least one turning frame depending on a geometry of a first double-walled part.

9. The turning device according to claim 1, wherein a plurality of fixing elements, preferably along a longitudinal extension of the at least one turning frame, are provided on the at least one turning frame, preferably wherein an actuating device is provided for each fixing element or wherein a number of actuating devices, preferably one or two actuating devices, smaller than the plurality of fixing elements are provided.

10. The turning device according to claim 1, wherein the at least one turning frame and/or the at least one drive unit are/is arranged on a machine frame, wherein it is preferably provided that the at least one turning frame is designed to be rotatable relative to the machine frame and/or the machine frame comprises at least one lifting unit for vertically lifting the at least one turning frame relative to the machine frame in a state of use of the turning device.

11. The turning device according to claim 1, wherein the pivoting and/or displacing of the at least one fixing element takes place in a plane parallel to a plane braced by the turning frame.

12. The turning device according to claim 1, further comprising at least one first double-walled part arranged in the at least one turning frame, wherein it is preferably provided that the first double-walled part comprises:
at least one, particularly preferably metallic, pallet for arranging liquid concrete on the pallet and/or
at least one edge formwork for locally limiting liquid concrete on the pallet and/or
at least one reinforcement for increasing the stability of the first double-walled part after hardening of the liquid concrete on the pallet and/or
at least one lattice girder projecting from the solid concrete arranged on the pallet for contacting a second double-walled part, and/or
at least one insulation arranged on the solid concrete arranged on the pallet.

13. The turning device according to claim 12, wherein the first double-walled part comprises a fixed edge formwork adjacent to the at least one turning frame and/or a variably placeable edge formwork placed on the pallet separately therefrom, wherein the at least one fixing element contacts the fixed edge formwork and/or the variably placeable edge formwork and/or the at least one lattice girder and/or the solid concrete arranged on the pallet and/or the insulation and/or the reinforcement for supporting the first double-walled part against the at least one turning frame.

14. A method for the fully automated bracing of a first double-walled part via the turning device according to claim 1, comprising the following method steps, in particular to be carried out in chronological order:
the first double-walled part is arranged at least in some portions within the at least one turning frame
the at least one controlling and/or regulating device displaces the at least one fixing element, preferably in a direction essentially orthogonal to a longitudinal extension of the turning frame, by means of the at least one actuating device
by means of the at least one displaced fixing element, the first double-walled part arranged at least in some portions within the turning frame relative to the at least one turning frame, is fixed
by means of the at least one drive unit, the at least one turning frame is rotated in an automated manner in a space via the at least one controlling and/or regulating device.

15. The method according to claim 14, wherein:
the at least one additional drive unit is controlled via the at least one controlling and/or regulating device in such a way that the at least one actuating device, preferably together with the at least one fixing element, which is at least temporarily motion-coupled to the actuating device, or the at least one guide carriage, is displaced depending on a geometry of a first double-walled part on the at least one turning frame, preferably in a direction essentially parallel to a longitudinal extension of the turning frame, and/or wherein
the at least one actuating device, preferably together with the at least one fixing element which is at least temporarily motion-coupled to the actuating device, or the at least one guide carriage, is pivoted, preferably before the at least one actuating device or the at least one guide carriage is displaced.
